(19) United States
(12) Patent Application Publication
(10) Pub. No.: US 2018/0093605 A1
(43) Pub. Date: Apr. 5, 2018

(54) METHODS AND SYSTEMS FOR UNIDIRECTIONAL AND BIDIRECTIONAL COMMUNICATIONS

(71) Applicant: GM GLOBAL TECHNOLOGY OPERATIONS LLC, Detroit, MI (US)

(72) Inventors: IDO ZELMAN, RA'ANANA (IL); ASAF DEGANI, TEL AVIV (IL)

(73) Assignee: GM GLOBAL TECHNOLOGY OPERATIONS LLC, Detroit, MI (US)

(21) Appl. No.: 15/282,524

(22) Filed: Sep. 30, 2016

(51) Int. Cl. B60Q 1/26; B60Q 5/00

(52) U.S. Cl. CPC B60Q 1/26; G05D 1/0088; B60Q 5/005

(57) ABSTRACT

Methods and systems are provided for notifying a user. In one embodiment, a method includes: receiving perception data from a sensing device; determining a presence of an agent based on the perception data. In response to the determined presence, determining at least one of a type and a location of the agent based on the perception data; and selectively communicating directly to the agent based on at least one of the type and the location of the agent.

### TECHNICAL FIELD

The technical field generally relates to communications between a robotic device and a human or other object, and more particularly to methods and systems for managing unidirectional and bidirectional communications between a robotic device and a human or other object.

### BACKGROUND

Various driving scenarios require communication or confirmation between two individuals. For example, when a vehicle is approaching a cross walk and an individual is about to or is walking across the cross walk, the individual typically looks to the individual driving the vehicle for acknowledgement of their presence and confirmation that they intend to stop. In another example, when a vehicle is waiting for a right-of-way at a non-signalized intersection, the driver of one vehicle looks to the driver of another vehicle to wave them on. In each of these examples, humans communicate informally and navigate the vehicle based on the informal communication.

An autonomous vehicle is, for example, a driverless vehicle that is automatically controlled to carry passengers from one location to another. Autonomous vehicles do not have the benefit of the presence of a human to communicate to other humans outside of the vehicle. Other autonomous robotic devices are similarly unable to communicate. Accordingly, it is desirable to provide methods and systems to manage communications from a robotic device such as an autonomous vehicle. It is further desirable to provide methods and systems to manage unidirectional and bidirectional communications between a robotic device and a human or other object. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for notifying a user. In one embodiment, a method includes: receiving perception data from a sensing device; determining a presence of an agent based on the perception data. In response to the determined presence, determining at least one of a type and a location of the agent based on the perception data; and selectively communicating directly to the agent based on at least one of the type and the location of the agent.

In one embodiment, a system includes a non-transitory computer readable medium. The non-transitory computer readable medium includes a first module that, by a processor, receives perception data from a sensing device, and that determines a presence of an agent based on the perception data. The non-transitory computer readable medium further includes a second module that, in response to the determined presence, determines, by a processor, at least one of a type and a location of the agent based on the perception data. The non-transitory computer readable medium further includes a third module that, by a processor, selectively communicates directly to the agent based on at least one of the type and the location of the agent.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle including a communication system in accordance with various embodiments;

FIG. 2 is a dataflow diagram illustrating a control module of the communication system in accordance with various embodiments;

FIG. 3 is a flowchart illustrating a communication management method in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments may be described herein in terms of functional and/or logical block components and various processing steps. It should be appreciated that such block components may be realized by any number of hardware, software, and/or firmware components configured to perform the specified functions. For example, an embodiment may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of control systems, and that the system described herein is merely one example embodiment.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in various embodiments.

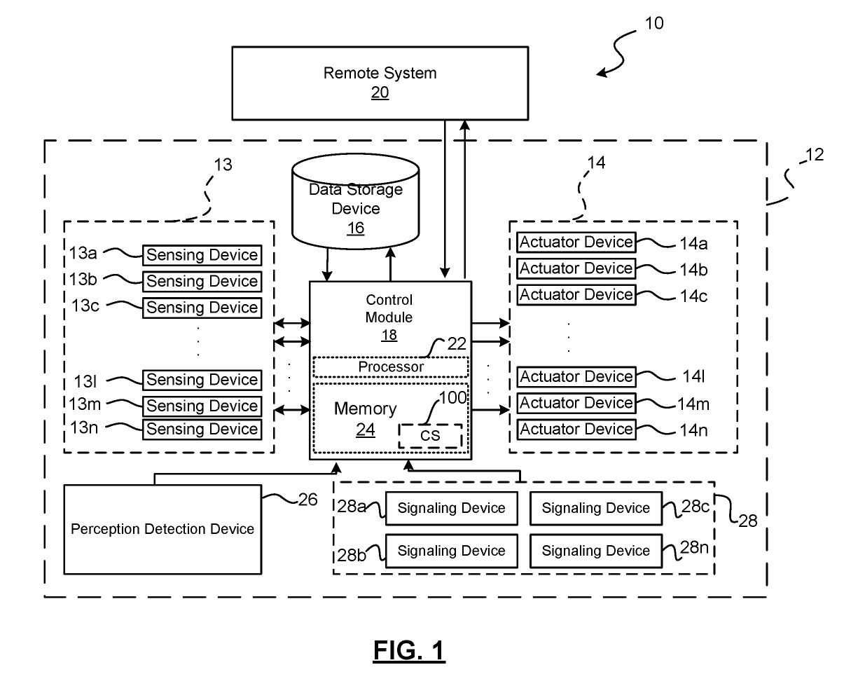

With reference now to FIG. 1, an exemplary communication system 10 is shown to be associated with a vehicle 12. As can be appreciated, the vehicle 12 may be any vehicle type such as, but not limited to a road vehicle, an off-road vehicle, an aircraft, a watercraft, a train, etc. As can further be appreciated, the communication system 10 may be associated with devices other than a vehicle 12, such as, but not limited to robotic devices, and is not limited to the present vehicle example. For exemplary purposes, the disclosure will be discussed in the context of the communication system 10 being associated with a vehicle 12.

Although the figures shown herein depict an example with certain arrangements of elements, additional intervening elements, devices, features, or components may be present in actual embodiments. It should also be understood that FIG. 1 is merely illustrative and may not be drawn to scale.

In various embodiments, the vehicle 12 is an autonomous vehicle. The autonomous vehicle 12 is, for example, a driverless vehicle that is automatically controlled to carry passengers from one location to another. For example, components of the autonomous vehicle 12 may include: a sensor system 13, an actuator system 14, a data storage device 16, and at least one control module 18. The sensor system 13 includes one or more sensing devices 13a-13n that sense observable conditions of the exterior environment and/or the interior environment of the vehicle 12. The sensing devices 13a-13n can include, but are not limited to, radars, lidars, and cameras. The actuator system 14 includes one or more actuator devices 14a-14n that control one or more vehicle components (not shown). In various embodiments, the vehicle components are associated with vehicle operation and can include, but are not limited to, a throttle, brakes, and a steering system. In various embodiments, the vehicle components are associated with interior and/or exterior vehicle features and can include, but are not limited to, doors, a trunk, and cabin features such as air, music, lighting, etc.

The data storage device 16 stores data for use in automatically controlling the vehicle 12. In various embodiments, the data storage device 16 stores defined maps of the navigable environment. In various embodiments, the defined maps may be predefined by and obtained from a remote system 20. For example, the defined maps may be assembled by the remote system 20 and communicated to the vehicle 12 (wirelessly and/or in a wired manner) and stored by the control module 18 in the data storage device 16. As can be appreciated, the data storage device 16 may be part of the control module 18, separate from the control module 18, or part of the control module 18 and part of a separate system.

The control module 18 includes at least one processor 22 and memory 24. The processor 22 can be any custom made or commercially available processor, a central processing unit (CPU), an auxiliary processor among several processors associated with the control module 18, a semiconductor based microprocessor (in the form of a microchip or chip set), a macroprocessor, or generally any device for executing instructions. The memory 24 may be one or a combination of storage elements that store data and/or instructions that can be performed by the processor 22. The instructions may include one or more separate programs, each of which comprises an ordered listing of executable instructions for implementing logical functions.

The instructions, when executed by the processor 22, receive and process signals from the sensor system 13, perform logic, calculations, methods and/or algorithms for automatically controlling the components of the vehicle 12, and generate control signals to the actuator system 14 to automatically control the components of the vehicle 12 based on the logic, calculations, methods, and/or algorithms. Although only one control module 18 is shown in FIG. 1, embodiments of the vehicle 12 can include any number of control modules 18 that communicate over any suitable communication medium or a combination of communication mediums and that cooperate to process the sensor signals, perform logic, calculations, methods, and/or algorithms, and generate control signals to automatically control features of the vehicle 12.

In various embodiments, the communication system 10 generally includes one or more instructions that are embodied within the control module 18 (as shown as the communication instructions 100. These instruction 100, when executed by the processor 22, generally detect the presence of an individual or object outside of the vehicle 12, and manage unidirectional and bidirectional communications between the detected individual or object outside of the vehicle 12. In various embodiments, the detected individual can be a pedestrian, a biker, a traffic conductor such as a policeman or construction worker, or other human in proximity to the vehicle 12. In various other embodiments, the detected object can be another autonomous vehicle, an emergency vehicle, infrastructure, or other object in proximity to the vehicle 12. For ease of the discussion, the disclosure will commonly refer to an individual and an object as an agent.

The communication system 10 detects the presence of the agent by way of at least one perception detection device 26. In various embodiments, the perception detection device 26 can include at least one sensing device such as, but not limited to, a camera, a radar, a lidar, or other sensing device that is disposed at one or more locations around the vehicle 12. As can be appreciated, the perception detection device 26 can be one or more of the sensing devices 13a-13n of the sensor system 13 discussed above for controlling the autonomy of the vehicle 12 and/or can be another sensing device dedicated to the communication system 10. The sensing device senses the environment around the outside of the vehicle 12 and generates sensor signals based thereon.

In various embodiments, the instructions 100 of the control module 18 receive the sensor signals from the perception detection device 26 and processes the sensor signals to detect whether an agent is in proximity to the vehicle 12, and generates data indicating the presence of an agent in proximity to the vehicle 12. For example, the instructions, when executed by the processor 22, detect an agent in the scene captured by the sensing device, determine a location of the agent (e.g., a location relative to the vehicle 12, or other coordinate system), determine a type of the agent (e.g., pedestrian, driver, biker, traffic conductor, infrastructure, emergency vehicle, other autonomous vehicle, personal device, etc.), and/or determines a gesture made by the agent (e.g., a head nod, a wave of a hand, stopping movement of the legs, etc.) and generates the data indicating the presence of the agent based on the location, type and/or the gesture.

In various embodiments, the instructions of the control module 18 process the data indicating the presence of the agent to determine whether the agent requires a communication, and if the agent requires a communication, what type of communication to communicate to the agent, where to make the communication such that it is directed to the agent, and for how long to communicate to the agent. In various embodiments, the instructions of the control module 18 process the data indicating the presence of the agent to determine whether the agent has confirmed receipt of the communication, for example, by way of a gesture (e.g., a head nod, a wave of the hand, stopping movement of the legs, etc.).

The communication system 10 communicates with the agent by way of a signaling system 28. The signaling system includes a plurality of signaling devices 28a-28n disposed at locations around the vehicle 12. A signaling device 28a is selected from the plurality of signaling devices 28a-28n for the communication based on the signaling device's location on the vehicle 12 and the agent's location relative to the vehicle 12. For example, a signaling device 28a located on the vehicle 12 in the direct line of site of the agent can be selected to make the communication to the agent.

In various embodiments, the signaling devices 28a-28n can include one or more visual devices, aural devices, and/or haptic devices. For example, the visual devices communicate an acknowledgement of the detection of the agent and/or gesture by, for example, displaying a particular light, a color of a light, a message, a predefined image, and/or a captured image of the agent. In another example, the aural devices communicate acknowledgment of the detection of the agent and/or gesture by, for example, playing a particular sound or a phrase. In still another example, the haptic devices communicate an acknowledgment of the detection of the agent or gesture by, activating a vibration.

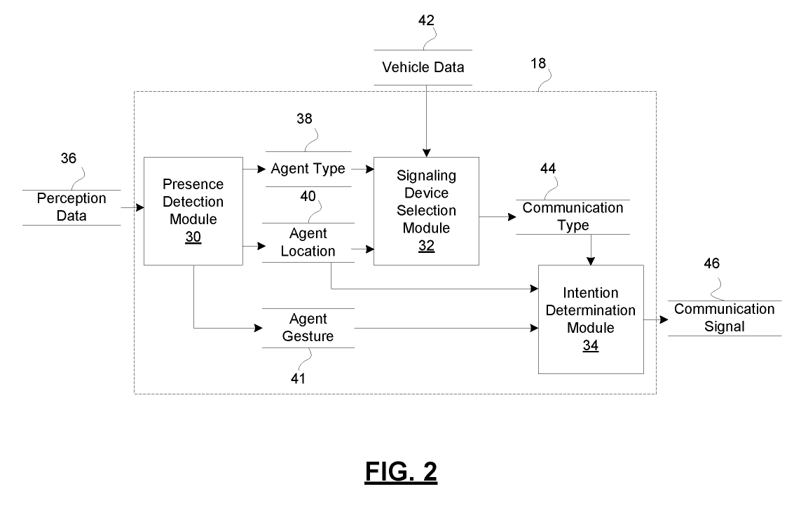

Referring now to FIG. 2 and with continued reference to FIG. 1, a dataflow diagram illustrates sub-modules of the control module 18 in more detail in accordance with various exemplary embodiments. As can be appreciated, various exemplary embodiments of the control module 18, according to the present disclosure, may include any number of modules and/or sub-modules. In various exemplary embodiments, the modules and sub-modules shown in FIG. 2 may be combined and/or further partitioned to similarly manage communications to and from an agent. In various embodiments, the control module 18 receives inputs from the perception detection device 26, from one or more of the sensors 13a-13n of the vehicle 12, from other modules (not shown) within the vehicle 12, and/or from other modules within the control module 18. In various embodiments, the control module 18 includes a presence detection module 30, a signaling device selection module 32, and a communication module 34.

The presence detection module 30 receives as input perception data 36 from the perception detection device 26. The presence detection module 30 processes the perception data 36 to determine whether an agent is in proximity to the vehicle 12. For example, a scene is constructed from the perception data 36 and elements within the scene are identified and classified into a type 38 using identification and classification techniques generally known in the art. If an element of the scene is classified as a type that is an agent (e.g., an individual or object), a location 40 of the element relative to the vehicle 12 is determined from the perception data 36. For example, the element can be determined to be located at a left front of the vehicle 12, a left back of the vehicle 12, a right front of the vehicle 12, a right back of the vehicle 12, a center front of the vehicle 12, a center back of the vehicle 12, a left side of the vehicle 12, a right side of the vehicle 1, etc. If an element of the scene is classified as an agent, then a gesture 41 of the agent is determined. For example, a position or posture of the agent is compared to a previous position or posture to determine the gesture 41.

The signaling device selection module 32 receives as input the type 38 of the agent, the location 40 of the agent, and vehicle data 42. The vehicle data 42 indicates a current operational status of the vehicle 12 such as, but not limited to, a braking status, steering status, a vehicle speed, etc. The signaling device selection module 32 determines if a communication should be made to the agent based on the type 38 of the agent, the location 40 of the agent, and the vehicle data 42. If it is determined that a communication should be made, the signaling device selection module 32 determines what type of communication should be made.

For example, the signaling device selection module 32 includes a plurality of scenarios. Each scenario is associated with one or more locations of agents and/or one or more types of agents. Each scenario includes one or more conditions of the vehicle 12 and associated communication types. The signaling device selection module 32 selects a scenario based on the type 38 of the agent and the location 40 of the agent, and evaluates the vehicle data 42 based on the selected scenario. If the vehicle data 42 indicates that conditions of the vehicle 12 under the scenario are met, then an associated communication type 44 is selected.

The communication module 34 receives as input the communication type 44, the location 40 of the agent, and the gesture 41 of the agent. The communication module 34 selects a signaling device based on the communication type 44 and the location 40 of the agent. For example, the communication module selects a signaling device located on the vehicle relative to a line of sight of the location of the agent. In another example, the communication module selects a signaling device 28a from the plurality of signaling devices 28a-28n that is best suited for the communication type 44. The communication module 34 generates communication signals 46 to communicate directly to the agent based on the selected signaling device 28a. In various embodiments, the communication module 34 ends the communication of the communication signals 46 when the agent is no longer present and/or when the gesture 41 of the agent indicates that the agent has confirmed the communication.

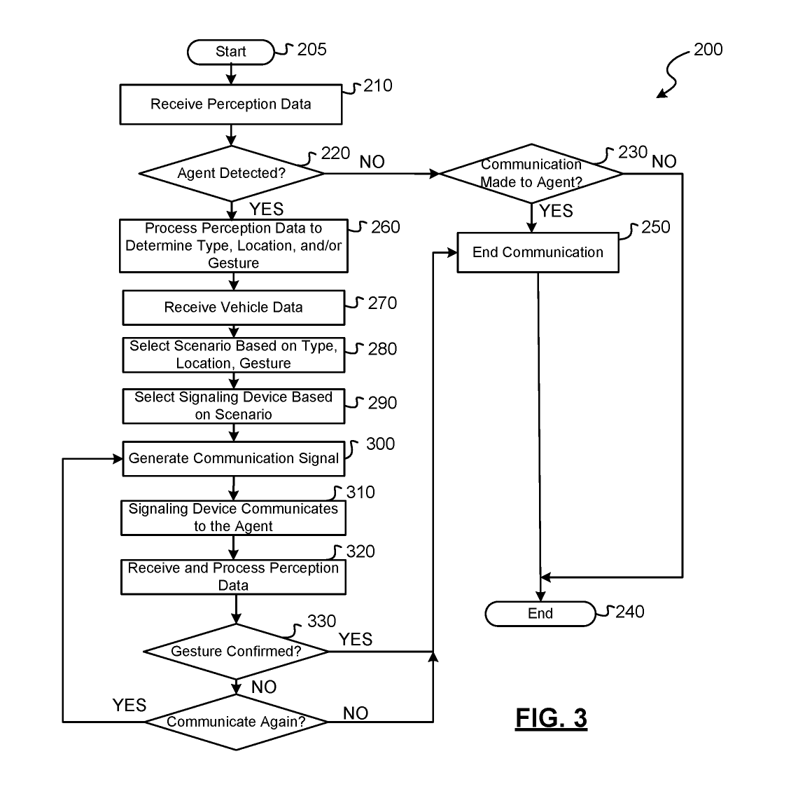

With reference now to FIG. 3, and with continued reference to FIGS. 1 and 2, a flowchart illustrates a method 200 for managing unidirectional and bidirectional communications between a vehicle and an agent. The method 200 can be implemented in connection with the vehicle of FIG. 1 and can be performed by the control module 18 of FIG. 2 in accordance with various exemplary embodiments. As can be appreciated in light of the disclosure, the order of operation within the method 200 is not limited to the sequential execution as illustrated in FIG. 3, but may be performed in one or more varying orders as applicable and in accordance with the present disclosure. As can further be appreciated, the method 200 of FIG. 3 may be enabled to run continuously, may be scheduled to run at predetermined time intervals during operation of the control module 18, and/or may be scheduled to run based on predetermined events.

In various embodiments, the method 200 may begin at 205. The perception data 36 is received from the perception detection device 26 at 210 and processed. It is determined whether an agent is present at 220. If an agent is not present, and a communication has not been previously sent to an agent at 230, the method may end at 240. If an agent is not present, and a communication was previously sent to the agent at 230, the communication is ended at 250, and the method may end at 240.

If, at 220, an agent is determined to be present, the perception data 36 is further processed to determine the location 40 and the type 38 of the agent at 260. Vehicle data 42 is received at 270. A scenario is selected based on the location 40 and/or the type 38 of the agent at 280. The vehicle data 42 is evaluated based on the selected scenario to select a signaling device 28a to make the communication, and to select the type of communication at 290. Communication signals 46 are then generated to the selected signaling device 28a based on the type of communication at 300. The signaling device 28a receives the communication signals 46 and communicates directly to the agent visually, aurally, and/or haptically at 310.

Optionally, a confirmation of the communication between the agent and the vehicle 12 can be made at 320-340. For example, additional perception data 36 is received at 320 and processed. It is determined whether the agent made a confirmation gesture at 330. If it is determined that the agent made a confirmation gesture at 330, the communication is ended at 250 and the method may end at 240. If it is determined that the agent did not make a confirmation gesture at 330, and it is desirable to communicate to the agent again at 340, communication signals 46 are then generated to the selected signaling device 28a based on the type of communication at 300. The signaling device receives the communication signals and communicates to the agent visually, aurally, and/or haptically at 310.

As can be appreciated, the perception data 36 can be evaluated for a confirmation gesture any number of times before proceeding to step 250 and ending the communication when the agent is no longer present.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method of notifying a user, comprising:
receiving perception data from a sensing device;
determining a presence of an agent based on the perception data;
in response to the determined presence,
determining a type of the agent based on the perception data;
selecting a signaling device from a group of different signaling devices based on the type of the agent; and
selectively communicating directly to the agent based on the type of the agent and the selected signaling device.

2. The method of claim 1, further comprising determining a gesture of the agent, and wherein the selectively communicating is based on the gesture of the agent.

3. The method of claim 2, confirming a communication from the agent based on the gesture.

4. (canceled)

5. The method of claim 1 further comprising selecting the signaling device based on the location of the agent, and wherein the selectively communicating is based on the selected signaling device

6. The method of claim 1, wherein the agent is a human in proximity of the vehicle.

7. The method of claim 1, wherein the agent is an object in proximity of the vehicle.

8. The method of claim 1, further comprising: determining a non-presence of an agent, and in response to the determined non-presence, stopping the communicating directly to the agent.

9. The method of claim 1, wherein the signaling device includes a visual communication device.

10. The method of claim 1, wherein the signaling device includes an audible communication device.

11. The method of claim 1, wherein the signaling device includes a haptic communication device.

12. A system for notifying a user, comprising:
a non-transitory computer readable medium, comprising:
a first module that, by a processor, receives perception data from a sensing device, and that determines a presence of an agent based on the perception data;
a second module that, in response to the determined presence, determines, by the processor, a type of the agent based on the perception data; and
a third module that, by the processor, selects a signaling device from a group of different signaling devices based on the type of the agent, and selectively communicates directly to the agent based on the type of the agent and the selected signaling device.

13. The system of claim 12, wherein the second module determines, by the processor, a gesture of the agent, and wherein the third module selectively communicates based on the gesture of the agent.

14. The system of claim 13, wherein the third module confirms a communication from the agent based on the gesture.

15. (canceled)

16. The system of claim 12, wherein the third module selects the signaling device based on the location of the agent, and selectively communicates based on the selected signaling device

17. The system of claim 12, wherein the agent is a human in proximity of the vehicle.

18. The system of claim 12, wherein the agent is an object in proximity of the vehicle.

19. The system of claim 12, wherein the third module, by the processor, determines a non-presence of an agent, and in response to the determined non-presence, stops the communicating directly to the agent.
